(19) United States
(12) Patent Application Publication
(10) Pub. No.: US 2024/0170216 A1
(43) Pub. Date: May 23, 2024

(54) FILM FOR MANUFACTURING AN ELECTRONIC COMPONENT

(71) Applicant: SAMSUNG ELECTRO-MECHANICS CO., LTD., Suwon-si (KR)

(72) Inventors: Jung Jin PARK, Suwon-si (KR); Dae Jin SHIM, Suwon-si (KR); Jung Jin PARK, Suwon-si (KR); Jae Won KIM, Suwon-si (KR); Hyo Sung CHOI, Suwon-si (KR); Ho Sam CHOI, Suwon-si (KR); Sun Mi KIM, Suwon-si (KR); Jong Ho LEE, Suwon-si (KR)

(73) Assignee: SAMSUNG ELECTRO-MECHANICS CO., LTD., Suwon-si (KR)

(21) Appl. No.: 18/218,234

(22) Filed: Jul. 5, 2023

(30) Foreign Application Priority Data
Nov. 21, 2022 (KR) 10-2022-0156639

(51) Int. Cl. H01G 4/14; B82Y 30/00

(52) U.S. Cl. CPC H01G 4/14; B82Y 30/00; H01G 4/306

(57) ABSTRACT

A film for manufacturing an electronic component includes a polymer layer and conductive nanowires and magnetic nanoparticles dispersed in the polymer layer.

### CROSS-REFERENCE TO RELATED APPLICATION(S)

This application claims benefit of priority to Korean Patent Application No. 10-2022-0156639 filed on Nov. 21, 2022 in the Korean Intellectual Property Office, the disclosure of which is incorporated herein by reference in its entirety.

### TECHNICAL FIELD

The present disclosure relates to a film for manufacturing an electronic component, and more particularly, to a film for manufacturing an electronic component used at the time of manufacturing multilayer an electronic component.

When a deviation in a fabric thickness of a polyester film used at the time of manufacturing a high-end thin/highly stacked multilayer ceramic capacitor (MLCC) increases, withstand voltage characteristics are decreased and a short-circuit rate is increased, due to an increase in a thickness dispersion of dielectric layers of the MLCC.

In addition, as the dielectric layer becomes thinner, mixing of foreign materials due to static electricity in a molding and stacking process (roll to roll) has a significant influence on characteristics of an MLCC product.

In the related art, in order to closely adhere and cool an extruded high-temperature film for manufacturing an electronic component on a casting roll, a static electricity applying agent is added to the film in a polymer polymerization step or the film is physically closely adhered and cooled through an air nozzle.

In this case, in order to impart an antistatic property to the film, a low molecular weight antistatic agent is injected into the film and moved to a surface or a solution is coated and dried on a surface of a finished film.

However, when an excessive amount of static electricity applying agent is added, compatibility of the static electricity applying agent in a melted polymer is decreased, which may cause a decrease in a surface roughness of a film.

In addition, in a case of the air nozzle, an optimal cooling condition is determined according to a distance between the air nozzle, a casting roll for cooling, and an extruded film, and a maximum cooling effect is not necessarily achieved at a maximum air volume. When an air volume is increased to significantly increase a degree of close adhesion and cooling efficiency of the extruded film, an air mark may be generated on a surface of the extruded film.

In addition, in the case of the related art, when a sheet constituting a dielectric layer is peeled from the film, it is charged due to a difference in work function between materials, which increases peeling force, causing a local decrease in a thickness of the dielectric layer due to wrinkles and tear defects.

Accordingly, by controlling the antistatic properties and flatness of the film to secure thickness smoothness of the extruded sheet formed in a casting process when manufacturing the film and imparting antistatic properties, there is a need for research on a film for manufacturing an electronic component capable of minimizing wrinkle defects and mixing of foreign materials that may occur in the MLCC manufacturing process.

### SUMMARY

An aspect of the present disclosure is to provide a film for manufacturing an electronic component for preventing generation of static electricity during a manufacturing process.

Another aspect of the present disclosure is to provide a film for manufacturing an electronic component for increasing cooling efficiency during a manufacturing process.

Another aspect of the present disclosure is to provide a film for manufacturing an electronic component having a uniform thickness.

Another aspect of the present disclosure is to provide a film for manufacturing an electronic component for facilitating peeling of a ceramic sheet and enabling manufacturing of the electronic component without damage, at the time of manufacturing the electronic component.

According to an aspect of the present disclosure, a film for manufacturing an electronic component, including a polymer layer and conductive nanowires and magnetic nanoparticles, dispersed in the polymer layer, may be provided.

### BRIEF DESCRIPTION OF DRAWINGS

The above and other aspects, features, and advantages of the present disclosure will be more clearly understood from the following detailed description, taken in conjunction with the accompanying drawings:

FIG. 1 is a schematic cross-sectional view illustrating a film for manufacturing an electronic component according to an exemplary embodiment in the present disclosure;

FIG. 2 is a schematic perspective view illustrating a film for manufacturing an electronic component of FIG. 1;

FIG. 3 is a schematic cross-sectional view illustrating an internal configuration of the film for manufacturing an electronic component according to an exemplary embodiment in the present disclosure;

FIG. 4 is a perspective view illustrating another example of conductive nanowires in the present disclosure;

FIG. 5 is a perspective view illustrating another example of conductive nanowires in the present disclosure;

FIG. 6 is a plan view of a film for manufacturing an electronic component according to a modified example in the present disclosure;

FIGS. 7 and 8 are process diagrams of a portion of manufacturing processes of a film for manufacturing an electronic component according to an exemplary embodiment in the present disclosure;

FIG. 9 is a schematic comparison graph illustrating an improvement effect of peeling force when the film for manufacturing an electronic component according to an exemplary embodiment in the present disclosure is used;

FIG. 10 is a schematic comparison graph illustrating an improvement effect of a wrinkle defect rate of a ceramic sheet when the film for manufacturing an electronic component according to an exemplary embodiment in the present disclosure is used; and

FIG. 11 is a schematic comparison graph illustrating an improvement effect of the number of times of the occurrence of a burnt phenomenon when the film for manufacturing an electronic component according to an exemplary embodiment in the present disclosure is used.

### DETAILED DESCRIPTION

Hereinafter, exemplary embodiments of the present disclosure will now be described with reference to specific embodiments and accompanying drawings.

The present disclosure may, however, be exemplified in many different forms and should not be construed as being limited to the specific embodiments set forth herein.

Rather, these embodiments are provided so that this disclosure will be thorough and complete, and will fully convey the scope of the disclosure to those skilled in the art.

Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express the present disclosure, and the size and thickness of each component shown in the drawings are arbitrarily shown for convenience of explanation, so the present disclosure not necessarily limited to what is shown.

In addition, the same elements having the same function within the scope of the same concept will be described with use of the same reference numerals.

Furthermore, throughout the specification, when a component is referred to as “comprise” or “comprising,” it means that it may further include other components as well, rather than excluding other components, unless specifically stated otherwise.

Films 10 and 11 for manufacturing an electronic component according to an exemplary embodiment and a modified example in the present disclosure may be used to manufacture an electronic component such as capacitors including multilayer ceramic capacitors (MLCCs), inductors, resistors, and the like.

As an example, the films 10 and 11 for manufacturing an electronic component may function as a base material for supporting a molded layer and a printed layer of a multilayer capacitor under the lowermost layer in a process of stacking the multilayer capacitor to easily fix the electronic component in the process of stacking the multilayer capacitor, and may serve to decrease generation of static electricity to block mixing of foreign materials.

In this case, the films 10 and 11 for manufacturing an electronic component may be peeled off from the electronic component after the process of stacking the multilayer capacitor.

Hereinafter, a configuration of the film for manufacturing an electronic component according to the present disclosure will be described in detail with reference to the drawings.

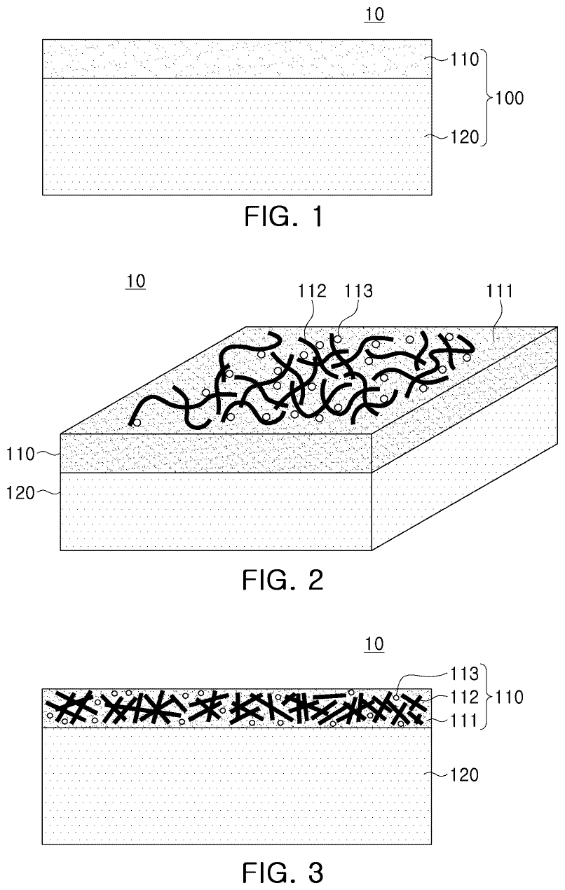

FIG. 1 is a schematic cross-sectional view illustrating a film for manufacturing an electronic component according to an exemplary embodiment in the present disclosure, FIG. 2 is a schematic perspective view illustrating the film for manufacturing an electronic component of FIG. 1, and FIG. 3 is a schematic cross-sectional view illustrating an internal configuration of the film for manufacturing an electronic component according to an exemplary embodiment in the present disclosure.

Referring to FIGS. 1 to 3, the film 10 for manufacturing an electronic component according to an exemplary embodiment may include a polymer layer 100 and conductive nanowires 112 and magnetic nanoparticles 113, dispersed in the polymer layer 110.

When magnetic nanoparticles capable of implementing both a magnetic property, and conductivity are mixed with conductive nanowires having a high aspect ratio described later, a content of a percolation threshold for electrical paths is lowered, and accordingly, an efficient antistatic effect can be expressed with a small content thereof.

The polymer layer 100 may include a front surface layer 110 and a rear surface layer 120 disposed on one surface of the front surface layer 110.

Conductive nanowires 112 and magnetic nanoparticles 113 may be dispersed in the front surface layer 110.

Specifically, the front surface layer 110 may include a first resin layer 111 and conductive nanowires 112 and magnetic nanoparticles 113, dispersed in the first resin layer 111.

The first resin layer 111 may include a polyester-based compound or a polyester-based polymer, and for example, a main repeating unit thereof may be at least one selected from ethylene terephthalate and ethylene naphthalate.

As an example, the first resin layer 111 may include polyethylene terephthalate (PET) formed by condensation polymerization of ethylene glycol with terephthalic acid.

In this case, ethylene glycol may be included in an amount of 0.01 to 0.5% by weight based on 100% by weight of the first resin layer.

In addition, polyethylene terephthalate may be prepared using a direct method using terephthalic acid described above, but may also be prepared by a DMT method using dimethyl terephthalate.

The rear surface layer 120 may include a second resin layer. The second resin layer may be made of the same or similar material as the first resin layer.

The rear surface layer 120 serves to maintain a shape of the film 10 for manufacturing an electronic component in a roll to roll process, of manufacturing the film 10 for manufacturing an electronic component, and serves to transfer smoothly the film 10 for manufacturing an electronic component in an elongation process in the roll to roll process.

In addition, the rear surface layer 120 may also serve to sufficiently maintain rigidity of the film 10 for manufacturing an electronic component during the manufacturing process.

An average thickness of the rear surface layer 120 may be greater than an average thickness of the front surface layer 110.

In the present disclosure, the ‘average thickness’ may not refer to a thickness in any one region, but may refer to an average value of thicknesses in a plurality of regions of a corresponding component.

For example, the average thickness of the front surface layer 110 may refer to an average value of values obtained by measuring the shortest distances between one surface and the other surface of the front surface layer 110 opposing each other in a stacked direction of the film 10 for manufacturing an electronic component, in five arbitrary regions spaced apart from each other in the front surface layer 110.

Meanwhile, the conductive nanowires 112 and the magnetic nanoparticles 113 may be dispersed not only in the front surface layer 110 but also inside the second resin layer of the rear surface layer 120, if necessary.

When the magnetic nanoparticles 113 are dispersed in the rear surface layer 120, the rear surface layer 120 adheres to a cooling roll (casting roll, 320) to be described later, and due to the magnetic property of the magnetic nanoparticles 113, antistatic properties and adhesion of the film 10 can be further improved.

In addition, the rear surface layer 120 serves as a ground to quickly release charges stored in the film, thereby preventing generation of static electricity.

The conductive nanowire 112 may be a wire-shaped structure having a size of a nanometer unit.

In this case, the conductive nanowires 112 may have a needle-like shape. That is, the conductive nanowire 112 may have a columnar shape extending in one direction, but an embodiment thereof is not limited thereto.

When the conductive nanowire 112 has the needle-like shape, an aspect ratio of the conductive nanowire 112 may be 10 to 500.

In addition, sheet resistance of the film 10 for manufacturing a final electronic component may be adjusted by mixing and dispersing a plurality of conductive nanowires 112 having a large aspect ratio difference in the first resin layer 111.

Meanwhile, synthesis of conductive nanowires may be made by a Vapor-Liquid-Solid (VLS) process, but the present disclosure is not limited thereto.

In addition, in the film 10 for manufacturing an electronic component according to an example of the present disclosure, the conductive nanowires 112 may include carbon, and may preferably be carbon nanotubes (CNT).

In this case, since the carbon nanotubes synthesize magnetic nanoparticles as a catalyst, a separate process of mixing magnetic nanoparticles in the manufacturing process can be omitted.

In addition, the carbon nanotubes may be surface treated in some cases for compatibility with a matrix resin of the first resin layer 111.

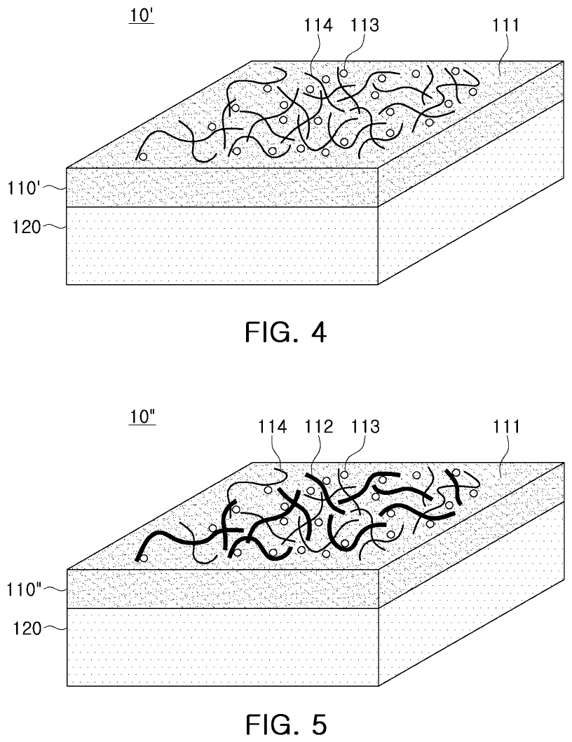

Meanwhile, as illustrated in FIG. 4, the conductive nanowire included in a front surface layer 110′ of a film 10′ may be a conductive polymer 114.

For example, as the conductive polymer, one or one more of poly(3,4-ethylenedioxythiophene (PEDOT), polypyrrole (PPy), and polyphenylene Sulfide (PPS) may be used. Preferably, as the conductive polymer, PEDOT may be used, and PEDOT may be mixed with PPY and PPS.

Electrical properties of the conductive polymer 114 are determined by a conjugated length and a degree of polymerization, and since it is aggregated in a content and degree of polymerization above a certain level, it is preferable to have a long conjugated length and an appropriate content and degree of polymerization.

In addition, as illustrated in FIG. 5, the conductive nanowires included in the front surface layer 110″ according to a functional purpose (e.g., ultra-smoothness) of the film 10″ and a required antistatic level may be also configured by mixing a carbon material 112 and a conductive polymer material 114.

For example, in the case of an ultra-smooth antistatic polyester film, frictional static electricity generated in a process of unwinding and winding the film during forming a dielectric layer may be zeroed out by including the carbon material and conductive polymer at the same time, and peeling static electricity generated on a peeling table during stacking may be zeroed out.

The magnetic nanoparticles 113 may include a monoatomic ferromagnetic metal, for example, nickel (Ni), cobalt (Co), iron (Fe), or an alloy of two or more thereof, but an embodiment thereof is not limited thereto.

The magnetic nanoparticles 113 may be synthesized as a single metal or configured in a form of plating coating or an alloy to realize characteristics.

Since the film 10 for manufacturing an electronic component according to an exemplary embodiment includes magnetic nanoparticles 113, cooling efficiency of an extruded melted film may be improved by closely adhering the extruded melted film to a casting roll or a cooling roll in a casting process to be described later, and the film 10 for manufacturing an electronic component may have an antistatic property to prevent damage to a ceramic layer due to static electricity.

Therefore, the film 10 for manufacturing an electronic component having a uniform thickness may be manufactured, a wrinkle defect that may occur in a stacking process due to the static electricity may be improved, and mixing of foreign materials due to the static electricity may be prevented, such that characteristics of the electronic component such as the MLCC may be finally improved.

TABLE 1

| | | | | | Amount (kV) | | |
|---|---|---|---|---|---|---|---|
| | | | | Whether | of Static | | |
| | | | | or not | Electricity | | |
| | | | Deviation | Magnetic | in unwinding | Amount (kV) | |
| | | Sheet | (max-min) | nanoparticles | unit during | of Peeling | Peeling |
| | Content | resistance | in thickness | are | molding and | Static | force |
| # | (wt %) | (Ω/□) | of film | aggregated | winding | Electricity | (mN) |
| REF. | 0 | 10¹⁴ | 1.2 | — | 3~4 | 5~10 | 100% |
| (Comparative | | | | | | | |
| Example) | | | | | | | |
| 1 | 0.05 | 10¹³ | 1.1 | None | 3~4 | 4~5 | 98% |
| 2 | 0.1 | 10¹³ | 0.9 | None | 3~4 | 3~4 | 95% |
| 3 | 0.2 | 10¹³ | 0.9 | None | 3~4 | 3~4 | 95% |
| 4 | 0.3 | 10¹³ | 0.9 | None | 3~4 | 3~4 | 95% |
| 5 | 0.5 | 10¹³ | 1.0 | Aggregated | 3~4 | 3~4 | 95% |

Comparative Example in Table 1 illustrates a film that does not contain magnetic nanoparticles and conductive nanowires.

Here, a content of the magnetic nanoparticles inside the film was analyzed by crushing the film as a destructive method and using as inductively coupled plasma mass spectrometer (ICP-MS) (measurement conditions: RF power: 1400 W, pump flow: rate: 1.0 ml/min, plasma mode: axial).

A deviation in a thickness of the film, whether or not magnetic nanoparticle are aggregated, and the like, were analyzed using TEM-BIDS. A thinned analysis sample was prepared from the manufactured film using a focused ion beam (FIB) equipment, a damage layer on a surface of the thinned sample was removed using Ar ion milling, and then each component was mapped and analyzed from an image obtained using STEM EDP.

Referring to Table 1, the content of the magnetic nanoparticies is preferably 0.3 wt % or less with respect to the content of the front surface layer.

As in #5, when the content of magnetic nanoparticies exceeds 0.3 wt % with respect to the content of the front surface layer, the content of magnetic nanoparticles may become high, such that a phenomenon in which the magnetic nanoparticles are aggregated the front surface layer may occur, which may decrease an antistatic property of the film.

In addition, referring to Table 1, when the magnetic nanoparticles are included in the front surface layer, a deviation in a thickness of a film for manufacturing a final electronic component may be decreased as compared with Comparative Example in which the magnetic nanoparticles are not included.

Here, the deviation in a thickness may refer to a value obtained by measuring thicknesses of a front surface layer including magnetic nanoparticles in a plurality of arbitrary plurality of regions, for example, in 10 different arbitrary regions, and by subtracting a minimum value (Min) from a maximum value (Max) of the measured thicknesses.

That is, as illustrated in Table 1, as the front surface layer may become uniform by including magnetic nanoparticles, and accordingly, an entire thickness of the film for manufacturing an electronic component may also become uniform.

In addition, referring to Table 1, it can be seen that when magnetic nanoparticles are included in the front surface layer, generation of static electricity is decreased as compared with Comparative Example in which the magnetic nanoparticles are not included.

Since the generation of the static electricity is decreased as described above, mixing of foreign materials in a roll to roll process for manufacturing the film for manufacturing an electronic component may be prevented, and when the electronic component such as the MLCC is stacked on the film 10 for manufacturing an electronic component later, a phenomenon in which the foreign materials are mixed into the electronic component may be prevented.

In addition, referring to Table 1, when the magnetic nanoparticles are included in the front surface layer, peeling force (mN) may be decreased as compared with Comparative Example in which the magnetic nanoparticles are not included.

In the present disclosure, “the decrease in the peeling force” means that the film for manufacturing an electronic component may be easily peeled off from the electronic component or the molded layer or the printed layer of the electronic component after a process of stacking the electronic component.

TABLE 2

| | | | | | Amount (kV) | | |
|---|---|---|---|---|---|---|---|
| | | | | Whether | of Static | | |
| | | | | or not | Electricity | | |
| | | | Deviation | Magnetic | in unwinding | Amount (kV) | |
| | | Sheet | (max-min) | nanoparticles | unit during | of Peeling | Peeling |
| | Content | resistance | in Thickness | are | molding and | Static | force |
| # | (wt %) | (Ω/□) | of Film | aggregated | winding | Electricity | (mN) |
| REF. | 0 | 10¹⁴ | 1.2 | — | 3~4 | 5~10 | 100% |
| (Comparative | | | | | | | |
| Example) | | | | | | | |
| 6 | 0.1 | 10¹² | 0.9 | None | 2~3 | 2~3 | 90% |
| 7 | 0.3 | 10¹² | 0.9 | None | 0.5-1 | 0.5-1 | 75% |
| 8 | 0.5 | 10⁹ | 0.9 | None | 0 | 0 | 55% |
| 9 | 1.0 | 10⁹ | 0.9 | None | 0 | 0 | 48% |
| 10 | 2.0 | 10⁹ | 1.1 | Aggregated | 0 | 0 | 40% |

In Table 2, when a content of the magnetic nanoparticies was fixed to be 0.1 wt % with respect to a content of the front surface layer and a content of the conductive nanowires is adjusted, properties of a film and a molded sheet were compared and illustrated. Here, carbon nanotubes were used as the conductive nanowires.

In addition, the content of conductive nanowires inside the film was analyzed by crushing the film as a destructive method and using an inductively coupled plasma mass spectrometer (ICP-MS) (measuring conditions: RF power: 1400 W, Pump flow rate: 1.0 ml/min, plasma mode: axial).

A deviation in a thickness of the film, whether or not magnetic nanoparticle are aggregated, and the like, were analyzed using TEM-EDS. A thinned analysis sample was prepared from the manufactured film using a focused ion beam (FIB) equipment, a damage layer on a surface of the thinned sample was removed using Ar ion milling, and then each component was mapped and analyzed from an image obtained using STEM-EDX.

Referring to Table 2, as in #10, when a content of the conductive nanowires exceeds 1.0 wt with respect to a content of the front surface layer, the content of the conductive nanowires may become high, such that a phenomenon in which the conductive nanowires are aggregated in the front surface layer may occur, which may decrease an antistatic property of a film.

In addition, referring to Table 2, when the conductive nanowire is included in the front surface layer, a deviation in a thickness of a film for manufacturing a final electronic component may be decreased as compared with Comparative example in which the conductive nanowires are not included, and the deviation in a thickness of the film was improved by about 25% as compared with Comparative Example in #9.

However, as in #10, when the content of the conductive nanowires exceeds 1.0 wt % with respect to a content of the front surface layer, it can be seen that the deviation in a thickness the film increases again.

Here, the deviation in a thickness may refer to a value obtained by measuring thicknesses of a front surface layer including magnetic nanoparticles and conductive nanowires in a plurality of arbitrary regions, for example, in 10 different arbitrary regions, and by subtracting a minimum value (Min) from a maximum value (Max) of the measured thicknesses.

That is, as illustrated in Table 2, when the front surface layer includes magnetic nanoparticles and conductive nanowires, and a content of the conductive nanowires is 1.0 wt % or less with respect to a content of the front surface layer, a more uniform surface layer can be obtained, and accordingly, an entire thickness for manufacturing an electronic component may also become uniform.

In addition, referring to Table 2, it can be seen that when the conductive nanowires are included in the front surface layer, generation of static electricity is decreased as compared with Comparative Example in which the conductive nanowires are not included.

Since the generation of the static electricity is decreased as described above, mixing of foreign materials in a roll to roll process for manufacturing the film for manufacturing an electronic component may be prevented, and when the electronic component such as the MLCC is stacked on the film for manufacturing an electronic component later, a phenomenon in which the foreign materials are mixed into the electronic component may be prevented.

In addition, referring to Table 2, when the conductive nanowires are included in the front surface layer, peeling force (mN) may be decreased as compared with Comparative Example in which the conductive nanowires are not included.

In the present disclosure, “the decrease in the peeling force” means that the film for manufacturing an electronic component may be easily peeled off from the electronic component or the molded layer or the printed layer of the electronic component after a process of stacking the electronic component.

As described above, a content of the conductive nanowires may be preferably 1.0 wt % or less with respect to a content of a front surface layer, and more preferably, the content of the conductive nanowires may be 0.5 to 1.0 wt % with respect to the content of the front surface layer, so that an amount static electricity in an unwinding unit and an amount of peeling static electricity during molding and winding may be zero.

TABLE 3

| | | | | | Amount (kV) | | |
|---|---|---|---|---|---|---|---|
| | | | | Whether | of Static | | |
| | | | | or not | Electricity | | |
| | | | Deviation | Magnetic | in unwinding | Amount (kV) | |
| | | Sheet | (max-min) | nanowires | unit during | of Peeling | Peeling |
| | Content | resistance | in Thickness | are | molding and | Static | Force |
| # | (wt %) | (Ω/□) | of Film | aggregated | winding | Electricity | (mN) |
| REF. | 0 | 10¹⁴ | 1.2 | — | 3~4 | 5~10 | 100% |
| (Comparative | | | | | | | |
| Example) | | | | | | | |
| 11 | 1.0 | 10¹² | 0.9 | None | 2~3 | 2~3 | 90% |
| 12 | 2.0 | 10¹² | 0.9 | None | 0.5-1 | 1~2 | 85% |
| 13 | 3.0 | 10⁹ | 0.9 | None | 0 | 0 | 47.5% |
| 14 | 4.0 | 10⁹ | 1.0 | Aggregated | 0 | 0 | 46% |
| 15 | 5.0 | 10⁹ | 1.1 | Aggregated | 0 | 0 | 45% |

In Table 3, when a content of the magnetic nanoparticies was fixed to be 0.1 wt % with respect to a content of the front surface layer and a content of the conductive nanowires is adjusted, properties of a film and a molded sheet were compared and illustrated. Here, conductive polymers were used as the conductive nanowires.

Referring to Table 3, as in #14 and 15, when a content of the conductive nanowires exceeds 3.0 wt % with respect to a content of the front surface layer, the content of the conductive nanowires may become nigh, such that a phenomenon in which the conductive nanowires are aggregated in the front surface layer may occur, which may decrease an antistatic property of a film.

In addition, referring to Table 3, when the conductive nanowire is included in the front surface layer, a deviation in a thickness of a film for manufacturing a final electronic component may be decreased as compared with Comparative example in which the conductive nanowires are not included, and the deviation in a thickness of the film was improved by about 25% as compared with Comparative Example in #13.

However, as in #14 and #15, when the content of the conductive nanowires exceeds 3.0 wt % with respect to a content of the front surface layer, it can be seen that the deviation in a thickness the film increases again.

Here, the deviation in a thickness may refer to a value obtained by measuring thicknesses of a front surface layer including magnetic nanoparticles and conductive nanowires in a plurality, of arbitrary regions, for example, in 10 different arbitrary regions, and by subtracting a minimum value (Min) from a maximum value (Max) of the measured thicknesses.

That is, as illustrated in Table 3, when the front surface layer includes magnetic nanoparticles and conductive nanowires, and a content of the conductive nanowires is 3.0 wt % or less with respect to a content of the front surface layer, a more uniform surface layer can be obtained, and accordingly, an entire thickness for manufacturing an electronic component may also become uniform.

In addition, referring to Table 3, it can be seen that when the conductive nanowires are included in the front surface layer, generation of static electricity is decreased as compared with Comparative Example in which the conductive nanowires are not included.

Since the generation of the static electricity is decreased as described above, mixing of foreign materials in a roll to roll process for manufacturing the film for manufacturing an electronic component may be prevented, and when the electronic component such as the MLCC is stacked on the film for manufacturing an electronic component later, a phenomenon in which the foreign materials are mixed into the electronic component may be prevented.

In addition, referring to Table 3, when the conductive nanowires are included in the front surface layer, peeling force (mN) may be decreased as compared with Comparative Example in which the conductive nanowires are not included.

In the present disclosure, “the decrease in the peeling force” means that the film for manufacturing an electronic component may be easily peeled off from the electronic component or the molded layer or the printed layer of the electronic component after a process of stacking the electronic component.

As described above, a content of the conductive nanowires may be preferably 3.0 wt % or less with respect to a content of a front surface layer, and more preferably, the content of the conductive nanowires may be 3.0 wt % with respect to the content of the front surface layer, so that an amount static electricity in an unwinding unit and an amount of peeling static electricity during molding and winding may be zero.

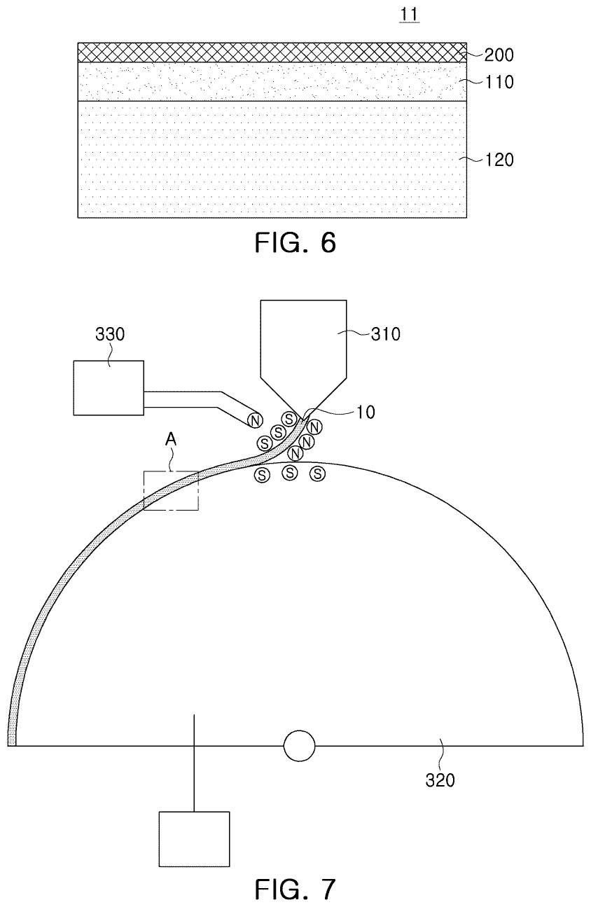

FIG. 6 is a cross-sectional view of a film for manufacturing an electronic component according to a modified example of the present disclosure.

Referring to FIG. 6, a film 11 for manufacturing an electronic component according to the modified example may include a front surface layer 110, a rear surface layer 120 disposed on one surface of the surface layer 110, and a release layer 200 disposed on the other surface opposing one surface of the front surface layer 110.

Since the film 11 for manufacturing an electronic component according to a modified example further includes only the release layer 200 as compared with the film 10 for manufacturing an electronic component according to an exemplary embodiment, a description for components other than the release layer 200 overlaps that described above in the film 10 for manufacturing an electronic component according to an exemplary embodiment.

The release layer 200 may be disposed on the other surface of the front surface layer 110 to allow the film 11 for manufacturing an electronic component to be easily peeled off from an electronic component to be disposed on the film 11 for manufacturing an electronic component later or a molded layer/printed layer of the electronic component.

The release layer 200 may be a silicon release layer. For example, the release layer 200 may include a colored coating composition including a mixed component including alkenyl polysiloxane and hydrogen polysiloxane, a platinum catalyst-containing compound, an epoxy-based compound, a dye, and the remaining amount of a solvent, and may have a structure in which the colored coating composition is applied once or more. Meanwhile, a material of the release layer 200 according to the present disclosure is not limited thereto.

As another example, the release layer 200 according to the present disclosure may include a silicone release composition containing dimethylpolysiloxane as main material.

In this case, the conductive nanowires 112 and the magnetic nanoparticies 113 may also be dispersed in the release layer 200. When the magnetic nanoparticles 113 are dispersed in the release layer 200, it may be effective in preventing static electricity when a dielectric sheet is peeled off.

In addition, in the film 11 for manufacturing an electronic component according to a modified example configured as described above, sheet resistance (ohm/sq (Ω/□)) of the release layer 200 may be kept low, and specifically, the sheet resistance of the release layer 200 on the other surface thereof may be 10¹⁰Ω/□ or less.

Accordingly, since an amount of static electricity generated in the roll to roll process may be controlled to be in a range of 0.01 to 0.1 kV, mixing of foreign materials, damage to the electronic component, and the like, due to the generation of the static electricity may be prevented.

A description for other components overlaps that described above in the film for manufacturing an electronic component according to an exemplary embodiment, and is thus omitted

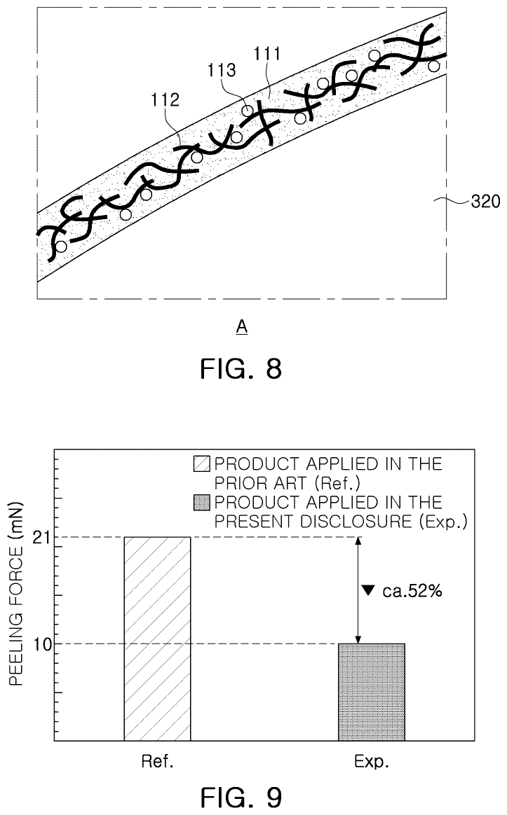

FIGS. 7 and 8 are process diagrams illustrating a portion of manufacturing some processes in manufacturing the film for manufacturing an electronic component according to an exemplary embodiment in the present disclosure.

Referring to FIGS. 7 and 8, a melted film 10 for manufacturing an electronic component including a front surface layer 110 and a rear surface layer 120 may be extruded from an extruder 310. The extruded melted film 10 for manufacturing an electronic component may have a temperature of 250° C. to 300° C., and may have a width of 1,000 to 2,000 mm.

In this case, two extruders may be applied to have a two-layer structure during extrusion, and a polyester resin containing conductive nanowires and magnetic nanoparticles may be applied to the front surface layer, and a polyester resin containing a filler (anti-blocking agent) having an average diameter of 2 to 5 μm may be applied to the rear surface layer thereof.

A thickness ratio of the front surface layer 110 and the rear surface layer 120 may be preferably 1:9 (front surface layer: rear surface layer) to 3:7.

In this case, in order to uniformly elongate the extruded melted film 10 for manufacturing an electronic component in a transverse direction and make a thickness of the extruded melted film for manufacturing an electronic component uniform, a degree of crystallinity in the extruded melted film 10 needs to be significantly decreased.

To this end, the extruded melted film 10 for manufacturing an electronic component of FIG. 7 may be closely adhered to a casting roll or a cooling roll 320 to be subjected to a cooling process.

The extruded melted film 10 for manufacturing an electronic component may have a temperature of 260° C. to 270° C., and may be cooled by the cooling roll 320 having a temperature of 20° C. to 25° C.

In this case, the front surface layer 110 of the melted film 10 for manufacturing an electronic component may be closely adhered to a surface of the cooling roll 320 so as to be in contact with the cooling roll 320, and the conductive nanowires 112 and the magnetic nanowires 113 may be included in the front surface layer 110 to secure a high close adhesion force.

In addition, in order to more efficiently perform the cooling process in the cooling roll 320, the melted film for manufacturing an electronic component needs to be more closely adhered to the cooling roll 320. In this case, a surface temperature of the cooling roll 320 may be 15° C. to 20° C.

As described above, the film 10 for manufacturing an electronic component according to the present disclosure may include the magnetic nanoparticles 112 therein to have a magnetic property.

Accordingly, in order to increase a degree of close adhesion between the melted film 10 for manufacturing an electronic component and the cooling roll 320, a magnetic band 330 may be used using characteristics of the film 10 for manufacturing an electronic component having the magnetic property.

A magnetic force of the magnetic band 330 may be about 0.05 N to 10 N, and as an example, the magnetic band may have a magnetic property of an N pole, such that a surface of the melted film 10 for manufacturing an electronic component close to the magnetic band 330 may have an S pole and a surface of the melted film 10 for manufacturing an electronic component close to the cooling roll 320 may have an N pole.

In this case, when the cooling roll 320 is controlled to have an S pole, the melted film 10 for manufacturing an electronic component may be closely adhered to the cooling roll 320 without physical damage by using a magnetic force. Meanwhile, control may also be performed so that a magnetic force is formed as opposed to the above-described example.

The cooled polyester extruded film may be elongated 1.5 times to 3 times in a longitudinal direction and elongated 2 to 4 times in the transverse direction to be manufactured as a film having a thickness of 15 μm to 50 μm.

In this case, surface resistance of the polyester film controlled to be less than 10¹⁰Ω/□, and static electricity generated in all roll to roll processes controlled to be in a range of 0.01 to 0.11 Kv.

Meanwhile, if necessary, after an extrusion and cooling process thereof, a silicone release composition containing dimethylpolysiloxane as a main material may be prepared, and the silicone release composition may be applied to a surface of the front surface layer to a thickness of 10 to 200 nm to form a release layer.

In general, the polyester film may be elongated and slitted in a longitudinal direction through a roll-to-roll process.

In addition, since a process of applying and stacking a dielectric layer and a printed layer on the film during manufacturing MLCC is also subjected to a roll to roll process, there is a high possibility in that foreign materials are mixed therein due to frictional static electricity.

Accordingly, in order to impart an antistatic property to the film and minimize the mixing of foreign materials in the process, as a method for closely adhering a melted film for manufacturing an electronic component in the related art, there may be a physical close adhesion method that uses an air nozzle or an electrical close adhesion method that uses addition of an antistatic agent and an electricity applying method.

In a case of the electrical close adhesion method, an extruded sheet is adhered to a casting roll and cooled by adding an electrostatic agent having a metal component during polyester resin polymerization and applying an electricity-applied wire device for inducing electrification within the sheet, and the general internal additives low molecular organic substances) do not have surface resistance characteristics of 10¹²Ω/□ or less, so that it has a weak antistatic effect, and it is difficult to secure dispersibility when a certain amount thereof is added.

In addition, due to excessive addition of the antistatic agent, the compatibility the molten polymer may be decreased, which may cause finally, a decrease in a surface roughness of the film.

In a case of the physical close adhesion method, an air mark may be generated on a surface of the extruded film due to spraying of an air nozzle, when an air volume is increased to maximize a degree of close adhesion and cooling efficiency, which may physically damage the surface of the melted film 10 and make a thickness thereof non-uniform.

In addition, in the case of the air nozzle, an optimal cooling condition may be determined according to a distance between the nozzle and the casting roll, and the extruded sheet, and the maximum air volume does not necessarily produce the maximum cooling effect.

In The case of the present disclosure, the melted film 10 for manufacturing an electronic component may be effectively attached to the cooling roll 320 without physical damage by using the magnetic nanoparticies having the magnetic property and the magnetic band 330 and the cooling roll 320 having the magnetic properties.

In addition, in order to maximize the cooling efficiency of the extruded melted film before being elongated in longitudinal and transverse directions during manufacturing a polyester film, magnetic nanoparticles are added to the inside of the film, and unlike the conventional method, a magnetic band is applied, and as a result, a deviation in a thickness of the release film may be improved.

That is, according to the present disclosure, in the technology added to the inside of the polyester film, it is possible to easily increase a cooling efficiency of the polyester sheet in the casting process and at the same time, it is possible to manufacture a functional polyester film having antistatic properties.

If such a technology is applied, a film having a uniform thickness may be manufactured and wrinkle defects and mixing of foreign materials caused by frictional static electricity and peeling electrification in a roll to roll process may be prevented, so that characteristics of a high-end thin/highly stacked multilayer may be improved.

FIG. 9 is a comparative graph schematically illustrating an effect of improving peeling force when a film for manufacturing an electronic component according to an exemplary embodiment in the present disclosure is used.

Referring to FIG. 9, a graph for comparing the peeling force of the film for manufacturing an electronic component according to an exemplary embodiment containing conductive nanowires and magnetic nanoparticles as in the present disclosure, as compared to a conventional film not containing conductive nanowires and magnetic nanoparticles, is illustrated.

As illustrated in the graph of FIG. 9, the film for manufacturing an electronic component according to an example may have peeling force that is reduced by about 52% compared to the conventional film, and as a result, it can be easily peeled off from an electronic component to be disposed on the film for manufacturing an electronic component according to an example later, or a printed layer of the electronic component to prevent damage to the electronic component or the printed layer.

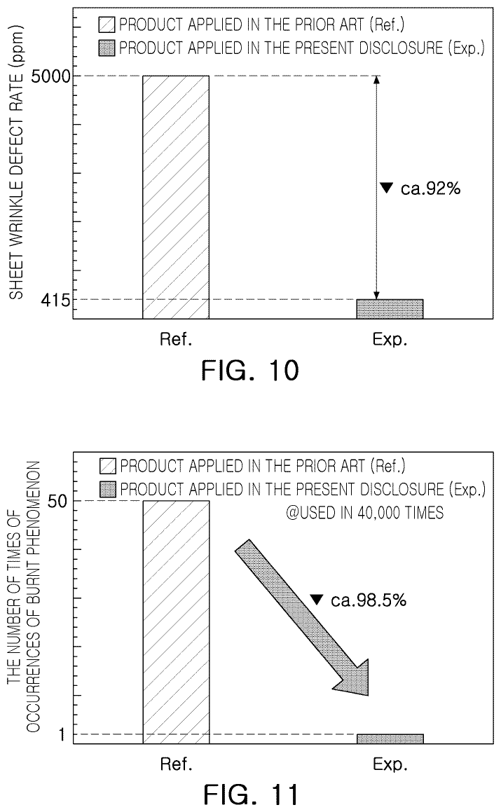

FIG. 10 is a comparative graph schematically illustrating an effect of improving a wrinkle defect rate of a printed layer when a film for manufacturing an electronic component according to an example of the present disclosure is used.

Referring to FIG. 10, a graph for comparing a wrinkle defect rate (ppm) of a film for manufacturing an electronic component according to an example including conductive nanowires and magnetic nanoparticles as in the present disclosure compared to a conventional film not including conductive nanowires and magnetic nanoparticles, is illustrated.

As illustrated in the graph of FIG. 10, the film for manufacturing an electronic component according to an example may have a wrinkle defect rate reduced by about 92% as compared to the conventional film because electrostatic force can be controlled when MLCC sheets are laminated, and may thus have a uniform average thickness.

As the thickness of the film is uniform, it is possible to prevent damage to an electronic component to be disposed on the film later, or a printed layer of the electronic component and mixing of foreign materials therein due to static electricity.

FIG. 11 is a schematic comparison graph illustrating an improvement effect of the number of times of the occurrence of a burnt phenomenon on a surface of a stacking facility member due to static electricity when the film for manufacturing an electronic component according to an exemplary embodiment in the present disclosure is used.

Referring to FIG. 11, a graph for comparing the number of times of the occurrence of a burnt phenomenon in which a product is burnt blackly by the film for manufacturing an electronic component according to an exemplary embodiment in the present disclosure that include the conductive nanowires 112 and the magnetic nanowires with the number of times of the occurrence of a burnt phenomenon in which a product is burnt blackly by the film according to the related art that does not include the conductive nanowires and the magnetic nanoparticles is illustrated.

When an antistatic property is not sufficiently implemented, an excessive voltage and current may be formed due to static electricity, such that current more than acceptable may flow, and thus, a burnt phenomenon may occur.

As illustrated in the graph of FIG. 11, it can be seen that the burnt phenomenon is decreased by about 98.5% in the film for manufacturing an electronic component according to an exemplary embodiment in the present disclosure as compared with the film according to the related art at a result of performing an experiment on 40,000 products, and accordingly, damage to a stacking member according to an exemplary embodiment may be prevented later.

As set forth above, according to one of the effects of the present disclosure, a film for manufacturing an electronic component for preventing generating static electricity during a manufacturing process, may be provided.

According to another one of the effects of the present disclosure, a film for manufacturing an electronic component for increasing cooling efficiency during the manufacturing process, may be provided.

According to another one of the effects of the present disclosure, a film for manufacturing an electronic component having a uniform thickness, may be provided.

As another effect of the present disclosure, by facilitating peeling the ceramic sheet during manufacturing an electronic component, and improving sheet wrinkle defects and foreign substrate defects caused by burnt portions, a film for manufacturing an electronic component capable of manufacturing an electronic component without damage, may be provided.

Although the embodiments of the present disclosure have been described in detail above, the present disclosure is not limited by the above-described embodiments and the accompanying drawings, and is intended to be limited by the appended claims.

Therefore, various forms of substitution, modification, and change will be possible by those skilled in the art within the scope of the technical spirit of the present disclosure described in the claims, which also falls within the scope of the present disclosure.

While example embodiments have been shown and described above, it will be apparent to those skilled in the art that modifications and variations could be made without departing from the scope of the present invention as defined by the appended claims.

What is claimed is:

1. A film for manufacturing an electronic component, comprising:
a polymer layer; and
conductive nanowires and magnetic nanoparticles dispersed in the polymer layer.

2. The film for manufacturing an electronic component of claim 1, wherein the polymer layer comprises a polyester-based compound.

3. The film for manufacturing an electronic component of claim 2, wherein the polyester-based compound includes polyethylene terephthalate (PET).

4. The film for manufacturing an electronic component of claim 1, wherein the conductive nanowires comprise carbon.

5. The film for manufacturing an electronic component of claim 4, wherein the conductive nanowires include carbon nanotubes.

6. The film for manufacturing an electronic component of claim 1, wherein the conductive nanowires comprise a conductive polymer.

7. The film for manufacturing an electronic component of claim 1, wherein the conductive nanowires comprise carbon and a conductive polymer.

8. The film for manufacturing an electronic component of claim 7, wherein the conductive nanowires comprise carbon nanotubes.

9. The film for manufacturing an electronic component of claim 1, wherein the magnetic nanoparticles comprise at least one of nickel (Ni), cobalt (Co), iron (Fe), or alloys thereof.

10. The film for manufacturing an electronic component of claim 1, wherein the polymer layer comprises a front surface layer and a rear surface layer disposed on one surface of the rear surface layer.

11. The film for manufacturing an electronic component of claim 10, wherein the conductive nanowires and the magnetic nanoparticles are dispersed in the front surface layer of the polymer layer.

12. The film for manufacturing an electronic component of claim 11, wherein the conductive nanowires and the magnetic nanoparticles are dispersed in the rear surface layer of the polymer layer.

13. The film for manufacturing an electronic component of claim 1, wherein the conductive nanowires have an aspect ratio of 10 to 500.

14. The film for manufacturing an electronic component of claim 10, wherein a content of the magnetic nanoparticles in the front surface layer is 0.3 wt % or less with respect to a content of the front surface layer.

15. The film for manufacturing an electronic component of claim 10, wherein the conductive nanowires include carbon nanotubes, and
a content of the carbon nanotubes in the front surface layer is 1.0 wt % or less with respect to a content of the front surface layer.

16. The film for manufacturing an electronic component of claim 15, wherein a content of the magnetic nanoparticles in the front surface layer is 0.3 wt % or less with respect to the content of the front surface layer.

17. The film for manufacturing an electronic component of claim 10, wherein the conductive nanowires include a conductive polymer, and
a content of the conductive polymer in the front surface layer is 3.0 wt % or less with respect to a content of the front surface layer.

18. The film for manufacturing an electronic component of claim 10, wherein the polymer layer further comprises a release layer disposed on the other surface of the front surface layer.

19. The film for manufacturing an electronic component of claim 18, wherein the conductive nanowires and the magnetic nanoparticles are dispersed in the front surface layer of the polymer layer.

20. The film for manufacturing an electronic component of claim 19, wherein the conductive nanowires and the magnetic nanoparticles are dispersed in the release layer of the polymer layer.
